(19) United States
(12) Patent Application Publication
(10) Pub. No.: US 2011/0246660 A1
(43) Pub. Date: Oct. 6, 2011

(54) Systems, Methods, and Apparatuses for Media File Streaming

(75) Inventor: Imed BOUAZIZI, Tampere (FI)

(73) Assignee: NOKIA CORPORATION, Espoo (FI)

(21) Appl. No.: 12/893,759

(22) Filed: Sep. 29, 2010

Related U.S. Application Data
(60) Provisional application No. 61/246,903, filed on Sep. 29, 2009.

(51) Int. Cl. G06F 15/16

(52) U.S. Cl. 709/231

(57) ABSTRACT

A method, apparatus, and system are provided for media file streaming. A method may include establishing a first communication channel with a server. The method may further include retrieving, by the first communication channel, at least a portion of a metadata file describing media data content of a media file. The method may additionally include establishing a second communication channel with the server. The method may also include retrieving, by the second communication channel, at least a portion of the media file based at least in part upon the retrieved at least a portion of the metadata file. Corresponding apparatuses and systems are also provided.

### RELATED APPLICATION

This application claims priority to U.S. application Ser. No. 61/246,903 filed Sep. 29, 2009, which is incorporated herein by reference in its entirety.

### TECHNOLOGICAL FIELD

Embodiments of the present invention relate generally to communications technology and, more particularly, relate to systems, methods, and apparatuses for media file streaming

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer. Current and future networking technologies as well as evolved computing devices making use of networking technologies continue to facilitate ease of information transfer and convenience to users. In this regard, the expansion of networks and evolution of networked computing devices has provided sufficient processing power, storage space, and network bandwidth to enable the transfer and playback of increasingly complex digital media files. Accordingly, Internet television and video sharing are gaining widespread popularity.

### BRIEF SUMMARY OF SOME EXAMPLES OF THE INVENTION

Systems, methods, apparatuses, and computer program products are therefore provided for facilitating streaming of media files. In this regard, systems, methods, apparatuses, and computer program products are provided that may provide several advantages to computing devices, computing device users, and network operators. Embodiments of the invention are configured to retrieve at least a portion of a metadata file describing a media file using a first communication channel with a server. Embodiments of the invention use the retrieved portion of the metadata file to identify a desired portion of the media file for retrieval and then retrieve the desired portion of the media file over a second communication channel with the server. In this regard, embodiments of the invention facilitate static streaming over a transfer protocol, such as hypertext transfer protocol (HTTP), in a way that may provide advantages to both a media content consumer and a server.

As a metadata describing a media file may be quite sizeable, embodiments of the invention provide an advantage in that embodiments of the invention split the metadata and media data into separate files (e.g., a file for metadata and one or more files for media data) that are retrieved by a media content consumer over two separate communication channels. Accordingly, a media content consumer is enabled by embodiments of the invention to retrieve media data and begin playback of the media data before all of the metadata describing the media file has been retrieved. From the perspective of a user of a media content consumer, embodiments of the invention may provide a better user experience wherein requested media content is played back for the user with less of a delay following the initial request than delays incurred using previous streaming methods. Servers may benefit in that embodiments of the invention allow a server to write a metadata file describing streaming live content piece by piece as more media data content becomes available.

In a first example embodiment, a method is provided, which comprises establishing a first communication channel with a server. The method of this embodiment further comprises retrieving, by the first communication channel, at least a portion of a metadata file describing media data content of a media file. The method of this embodiment additionally comprises establishing a second communication channel with the server. The method of this embodiment also comprises retrieving, by the second communication channel, at least a portion of the media file based at least in part upon the retrieved at least a portion of the metadata file.

In another example embodiment, an apparatus is provided. The apparatus of this embodiment comprises at least one processor and at least one memory storing computer program code, wherein the at least one memory and stored computer program code are configured to, working with the at least one processor, cause the apparatus to at least establish a first communication channel with a server. The at least one memory and stored computer program code are configured to, working with the at least one processor, further cause the apparatus of this embodiment to retrieve, by the first communication channel, at least a portion of a metadata file describing media data content of a media file. The at least one memory and stored computer program code are configured to, working with the at least one processor, additionally cause the apparatus of this embodiment to establish a second communication channel with the server. The at least one memory and stored computer program code are configured to, working with the at least one processor, also cause the apparatus of this embodiment to retrieve, by the second communication channel, at least a portion of the media file based at least in part upon the retrieved at least a portion of the metadata file.

In another example embodiment, a computer program product is provided. The computer program product of this embodiment includes at least one computer-readable storage medium having computer-readable program instructions stored therein. The computer program product of this embodiment comprises program instructions configured, when executed by a processor, to cause an apparatus to establish a first communication channel with a server. The computer program product of this embodiment further comprises program instructions configured, when executed by a processor, to cause an apparatus to retrieve, by the first communication channel, at least a portion of a metadata file describing media data content of a media file. The computer program product of this embodiment additionally comprises program instructions configured, when executed by a processor, to cause an apparatus to establish a second communication channel with the server. The computer program product of this embodiment also comprises program instructions configured, when executed by a processor, to cause an apparatus to retrieve, by the second communication channel, at least a portion of the media file based at least in part upon the retrieved at least a portion of the metadata file.

In another example embodiment, an apparatus is provided, which comprises means for establishing a first communication channel with a server. The apparatus of this embodiment further comprises means for retrieving, by the first communication channel, at least a portion of a metadata file describing media data content of a media file. The apparatus of this embodiment additionally comprises means for establishing a second communication channel with the server. The apparatus of this embodiment also comprises means for retrieving, by the second communication channel, at least a portion of the media file based at least in part upon the retrieved at least a portion of the metadata file.

In another example embodiment, a method is provided, which comprises establishing a first communication channel with a media content consumer. The method of this embodiment further comprises providing, by the first communication channel, at least a portion of a metadata file describing media data content of a media file. The method of this embodiment additionally comprises establishing a second communication channel with the media content consumer. The method of this embodiment also comprises providing, by the second communication channel, at least a portion of the media file, the provided at least a portion of the media file requested by the media content consumer based at least in part upon the provided at least a portion of the metadata file.

In another example embodiment, an apparatus is provided. The apparatus of this embodiment comprises at least one processor and at least one memory storing computer program code, wherein the at least one memory and stored computer program code are configured to, working with the at least one processor, cause the apparatus to at least establish a first communication channel with a media content consumer. The at least one memory and stored computer program code are configured to, working with the at least one processor, further cause the apparatus of this embodiment to provide, by the first communication channel, at least a portion of a metadata file describing media data content of a media file. The at least one memory and stored computer program code are configured to, working with the at least one processor, also cause the apparatus of this embodiment to establish a second communication channel with the media content consumer. The at least one memory and stored computer program code are configured to, working with the at least one processor, additionally cause the apparatus of this embodiment to provide, by the second communication channel, at least a portion of the media file, the provided at least a portion of the media file requested by the media content consumer based at least in part upon the provided at least a portion of the metadata file.

In another example embodiment, a computer program product is provided. The computer program product of this embodiment includes at least one computer-readable storage medium having computer-readable program instructions stored therein. The computer program product of this embodiment comprises program instructions configured, when executed by a processor, to cause an apparatus to establish a first communication channel with a media content consumer. The computer program product of this embodiment further comprises program instructions configured, when executed by a processor, to cause an apparatus to provide, by the first communication channel, at least a portion of a metadata file describing media data content of a media file. The computer program product of this embodiment additionally comprises program instructions configured, when executed by a processor, to cause an apparatus to establish a second communication channel with the media content consumer. The computer program product of this embodiment also comprises program instructions configured, when executed by a processor, to cause an apparatus to provide, by the second communication channel, at least a portion of the media file, the provided at least a portion of the media file requested by the media content consumer based at least in part upon the provided at least a portion of the metadata file.

In another example embodiment, an apparatus is provided, which comprises means for establishing a first communication channel with a media content consumer. The apparatus of this embodiment further comprises means for providing, by the first communication channel, at least a portion of a metadata file describing media data content of a media file. The apparatus of this embodiment additionally comprises means for establishing a second communication channel with the media content consumer. The apparatus of this embodiment also comprises means for providing, by the second communication channel, at least a portion of the media file, the provided at least a portion of the media file requested by the media content consumer based at least in part upon the provided at least a portion of the metadata file.

In another example embodiment, a system is provided. The system of this embodiment comprises a media content consumer and a server. The media content consumer of this embodiment is configured to establish a first communication channel with the server. The media content consumer of this embodiment is further configured to retrieve from the server, by the first communication channel, at least a portion of a metadata file describing media data content of a media file. The media content consumer of this embodiment is additionally configured to establish a second communication channel with the server. The media content consumer of this embodiment is also configured to retrieve from the server, by the second communication channel, at least a portion of the media file based at least in part upon the retrieved at least a portion of the metadata file. The server of this embodiment is configured to provide, by the first communication channel, the at least a portion of the metadata file to the media content consumer. The server of this embodiment is further configured to provide, by the second communication channel, the at least a portion of the media file to the media content consumer.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 illustrates a system for facilitating streaming of media files according to an exemplary embodiment of the present invention;

FIG. 2 is a schematic block diagram of a mobile terminal according to an exemplary embodiment of the present invention;

FIG. 3 illustrates ISOFF-compliant structured media content that may be formatted in accordance with one example embodiment of the invention; and

FIGS. 4-8 illustrate flowcharts according to exemplary methods for facilitating streaming of media files according to an exemplary embodiment of the present invention.

### DETAILED DESCRIPTION

Some embodiments of the present invention will now be described more fully hereinafter with reference to the accompanying drawings, in which some, but not all embodiments of the invention are shown. Indeed, it should be appreciated that many other potential embodiments of the invention, in addition to those illustrated and described herein, may be embodied in many different forms. Embodiments of the present invention should not be construed as limited to the embodiments set forth herein; rather, the embodiments set forth herein are provided so that this disclosure will satisfy applicable legal requirements. Like reference numerals refer to like elements throughout.

As used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

Some multimedia content providers use real-time transport protocol (RTP) over user datagram protocol (UDP) for media streaming (also referred to as real-time streaming protocol (RTSP)). In this regard, UDP provides basic transport functionality, such as application addressing and corruption detection. RTP complements UDP with media transport relevant functionality, such as loss detection, packet re-ordering, synchronization, statistical data collection, and session participant identification. However, RTP over UDP (RTP/UDP) does not provide built-in congestion control and/or error correction functionality. RTP/UDP may gather sufficient information for implementing congestion control and/or error correction functionality on a need basis at an application level. In this regard, with the rising popularity of mobile and internet video, it is desired to maintain good network behavior through appropriate rate control mechanisms. In RTP/UDP-based streaming applications, the sender and/or receiver of the streaming media, if not appropriately configured, may fail to traverse network address translation (NAT) device(s) and/or a firewall(s) positioned in the streaming path between the sender and receiver.

Hypertext transfer protocol (HTTP) streaming media delivery is replacing RTSP/RTP-based streaming in some applications. Even though HTTP was not designed for the delivery of real-time media, HTTP provides benefits that make it attractive for streaming media content delivery applications. In this regard, HTTP is relatively easy to setup and deploy. Additionally, HTTP media delivery overcomes NAT and firewall traversal issues that hinder use of RTSP/RTP-based streaming. Further, HTTP is widely deployed with a very robust infrastructure (such as HTTP caches) that enables efficient data distribution.

HTTP is an application-level transfer protocol that was developed for the delivery of hyperlinked text documents. The usages of the protocol have evolved further to cover the delivery of files of different types of files and data. HTTP uses a request/response model to retrieve remote resources from a web server. The client establishes a transport protocol communication channel (e.g., a transmission control protocol (TCP) communication channel) with the server, typically on port 80, and exchanges HTTP messages with the server. An HTTP message may comprise a header portion and an optional body portion. The header portion may comprise a sequence of HTTP header fields, each ending with a carriage return/line feed character. The HTTP message header may be separated from the HTTP message body by an empty line. The HTTP header fields are provided in a human-readable textual format. A Uniform Resource Locator (URL or URI) is used to identify and locate the resource that is to be retrieved by the HTTP client. A URI comprises a protocol identifier, a fully qualified domain name, a path to the requested resource, and optionally a query string.

HTTP may be used for the delivery of real-time media, such as audio/video content, in a mode called progressive download. In this approach, the client retrieves the media file as a normal file. It then starts the playback of the received file after a short start-up delay. The HTTP progressive streaming is transparent to the HTTP server and is performed at the client only. However, a media preparation step may be necessary to enable progressive download. In this regard, the server may need to convert the media file into a format that enables the client to start playback as soon as possible. One such format that is suitable for progressive download is the International Organization for Standardization (ISO)-base media File Format (ISOFF). This format allows the content source to place metadata information describing the media data content of the media file at the beginning of the media file. Storing the metadata at the beginning of the file allows the media content consumer to first retrieve all metadata and then start receiving the media data. The received media data may then be played back using the previously received metadata. However, this methodology generally results in very long initial delay before playback begins. This delay is attributable due to the metadata information typically being very large and the requirement that the entirety of the metadata be retrieved prior to retrieving any of the media data of the media file.

The ISOFF is designed in an object-oriented manner. In this regard, an ISOFF compliant file is composed of a set of boxes that may be inherited and extended through the definition of new boxes. All information in an ISOFF-compliant file must be contained in a box. A box may itself contain other boxes. Each box is identified by a unique type, which is typically defined as a 4 byte type (4 characters). Each box also indicates the length of the box, including the header of the box. These two fields are defined by the “Box” box, which is inherited by all ISOFF boxes. An ISOFF-compliant media file starts with an “ftyp” box that indicates the brand and the type of the box. The metadata related to the file is stored in the “moov” box. The media data itself is stored in the “mdat” box or it may be stored externally in separate files. In the latter case, appropriate references to the media data is provided through uniform resource locaters (URLs) or uniform resource names (URNs) that are provided by “dref' boxes. The “moov” box contains “trak” boxes that store information about the media tracks in an ISOFF-compliant file. Each track stores information about the samples of the corresponding media track, including their location, their size, their descriptive information, and their timing information

Due to the large size of the metadata information and the requirement that the entirety of the metadata information be retrieved prior to retrieval of any media data content, conventional progressive download for HTTP streaming suffers significantly in the form of playback delays. In the example of ISOFF-compliant media files, the metadata information contained in the “moov” box contains information about all samples in the file. The total size of the moov box may amount to several megabytes. Downloading the full “moov” box may take several minutes. This is even more problematic when a user is attempting to sample media content to choose the appropriate content to consume. In this regard, when conventional HTTP streaming techniques are used, the user may have to wait for several minutes to be able to start to play the file while the entirety of the metadata (also referred to as a ‘manifest’) is retrieved. This delay may severely impact the user's experience when the user may merely play before the media content for a couple of seconds to determine whether the user wishes to view the entire media file before moving to the next content file.

A further problem with conventional HTTP streaming techniques may arise if the media file contains more than one track per media type. For example, the video media may be encoded at multiple bitrates and stored in the same media file. Another example is the case of multiple audio tracks that correspond to multiple audio languages. In these cases, the client may end up downloading more media data than it requires for the playback of the content. In many cases, this downloading of additional media data will result in playback interruptions induced by a much higher bit rate requirement than the available bandwidth.

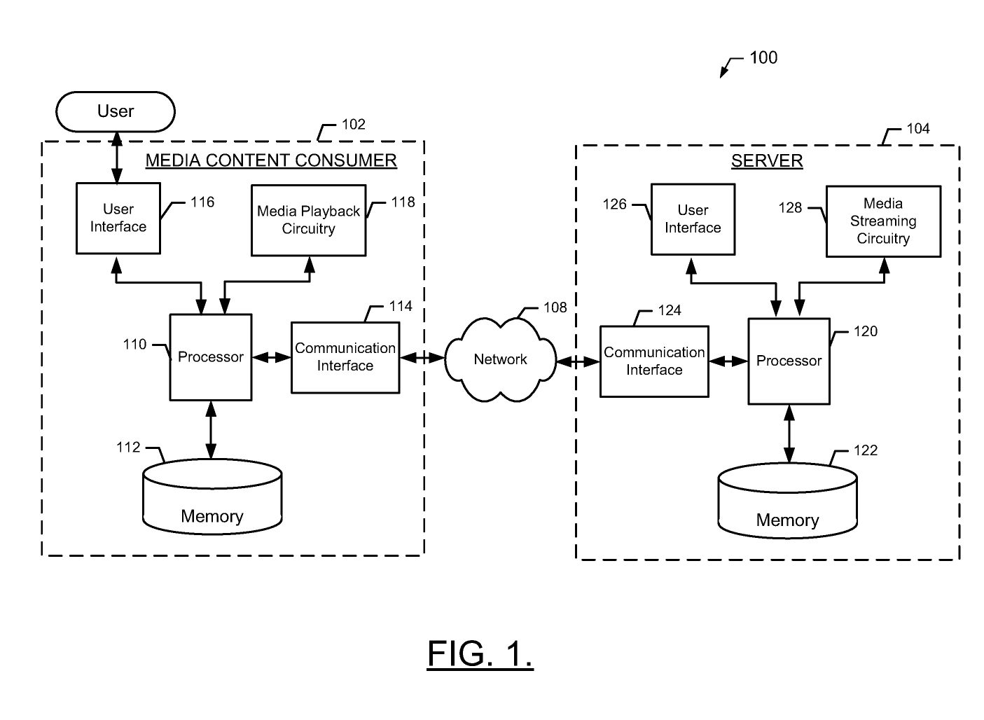

Accordingly, embodiments of the invention provide systems, methods, apparatuses, and computer program products that may address some of the deficiencies of conventional media streaming techniques. FIG. 1 illustrates a block diagram of a system 100 for facilitating streaming of media files according to an exemplary embodiment of the present invention. As used herein, “exemplary” merely means an example and as such represents one example embodiment for the invention and should not be construed to narrow the scope or spirit of the invention in any way. It will be appreciated that the scope of the invention encompasses many potential embodiments in addition to those illustrated and described herein. As such, while FIG. 1 illustrates one example of a configuration of a system for facilitating streaming of media files, numerous other configurations may also be used to implement embodiments of the present invention. Further, it should be appreciated that hypertext transfer protocol (HTTP) is used as an example of an application layer transfer protocol that may be used for streaming of media files in accordance with some embodiments of the invention. Other embodiments of the invention are configured to stream media files using other application layer transfer protocols in addition to or in lieu of HTTP.

Accordingly, FIG. 1 illustrates a block diagram of a system 100 for streaming media files using an application layer transfer protocol, such as hypertext transfer protocol (HTTP), according to an example embodiment of the present invention. In an example embodiment, the system 100 comprises a media content consumer 102 and a server 104. The media content consumer 102 and the server 104 are configured to communicate over a network 108. The network 108, for example, comprises one or more wireline networks, one or more wireless networks, or some combination thereof. In some embodiments, the network 108 comprises a public land mobile network (PLMN) operated by a network operator. In this regard, the network 108 may comprise, for example, an operator network providing cellular network access, such as in accordance with 3GPP standards. The network 108 may additionally or alternatively comprise the internet.

The media content consumer 102 comprises any device configured to access media files from a server 104 over the network 108. In various example embodiments, the media content consumer 102 comprises a server, a desktop computer, a laptop computer, a mobile terminal, a mobile computer, a mobile phone, a mobile communication device, a game device, a digital camera/camcorder, an audio/video player, a television device, a radio receiver, a digital video recorder, a positioning device, any combination thereof, and/or the like.

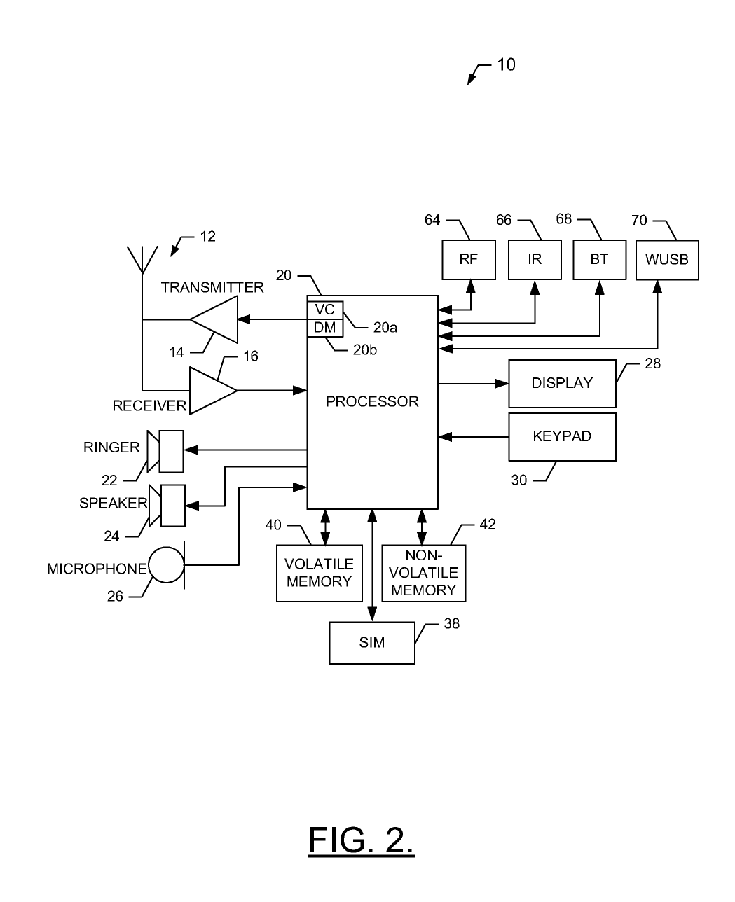

In an example embodiment, the media content consumer 102 is embodied as a mobile terminal, such as that illustrated in FIG. 2. In this regard, FIG. 2 illustrates a block diagram of a mobile terminal 10 representative of one embodiment of a media content consumer 102 in accordance with embodiments of the present invention. It should be understood, however, that the mobile terminal 10 illustrated and hereinafter described is merely illustrative of one type of media content consumer 102 that may implement and/or benefit from embodiments of the present invention and, therefore, should not be taken to limit the scope of the present invention. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ embodiments of the present invention.

In this regard, FIG. 2 illustrates a block diagram of a mobile terminal 10 representative of one embodiment of a media content consumer 102 in accordance with embodiments of the present invention. It should be understood, however, that the mobile terminal 10 illustrated and hereinafter described is merely illustrative of one type of media content consumer 102 that may implement and/or benefit from embodiments of the present invention and, therefore, should not be taken to limit the scope of the present invention. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ embodiments of the present invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wireless-Fidelity (Wi-Fi), wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (e.g., session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of operating according to Wireless Fidelity (Wi-Fi) or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (e.g., software and/or firmware) stored on a memory accessible to the processor 20 (e.g., volatile memory 40, non-volatile memory 42, and/or the like). Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise numeric (0-9) and related keys (#, *), and/or other keys for operating the mobile terminal.

As shown in FIG. 2, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, a wireless universal serial bus (USB) transceiver 70 and/or the like. The Bluetooth™ transceiver 68 may be capable of operating according to ultra-low power Bluetooth™ technology (e.g., Wibree™) radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wireless Fidelity (Wi-Fi), WLAN techniques such as IEEE 802.11 techniques, IEEE 802.15 techniques, IEEE 802.16 techniques, and/or the like.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Referring again to FIG. 1, in an example embodiment, the media content consumer 102 comprises various means, such as a processor 110, a memory 112, a communication interface 114, a user interface 116, and media playback circuitry 118, for performing the various functions herein described. These means of the media content consumer 102 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 112) that is executable by a suitably configured processing device (e.g., the processor 110), or some combination thereof.

The processor 110 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 1 as a single processor, in some embodiments the processor 110 comprises a plurality of processors. The plurality of processors may be in operative communication with each other and may be collectively configured to perform one or more functionalities of the media content consumer 102 as described herein. In embodiments wherein the media content consumer 102 is embodied as a mobile terminal 10, the processor 110 may be embodied as or comprise the processor 20. In an exemplary embodiment, the processor 110 is configured to execute instructions stored in the memory 112 or otherwise accessible to the processor 110. These instructions, when executed by the processor 110, may cause the media content consumer 102 to perform one or more of the functionalities of the media content consumer 102 as described herein. As such, whether configured by hardware or software methods, or by a combination thereof, the processor 110 may comprise an entity capable of performing operations according to embodiments of the present invention while configured accordingly. Thus, for example, when the processor 110 is embodied as an ASIC, FPGA or the like, the processor 110 may comprise specifically configured hardware for conducting one or more operations described herein. Alternatively, as another example, when the processor 110 is embodied as an executor of instructions, such as may be stored in the memory 112, the instructions may specifically configure the processor 110 to perform one or more algorithms and operations described herein.

The memory 112 may include, for example, volatile and/or non-volatile memory. Although illustrated in FIG. 1 as a single memory, the memory 112 may comprise a plurality of memories. The memory 112 may comprise volatile memory, non-volatile memory, or some combination thereof. In this regard, the memory 112 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the media content consumer 102 is embodied as a mobile terminal 10, the memory 112 may comprise the volatile memory 40 and/or the non-volatile memory 42. The memory 112 may be configured to store information, data, applications, instructions, or the like for enabling the media content consumer 102 to carry out various functions in accordance with exemplary embodiments of the present invention. For example, in at least some embodiments, the memory 112 is configured to buffer input data for processing by the processor 110. Additionally or alternatively, in at least some embodiments, the memory 112 is configured to store program instructions for execution by the processor 110. The memory 112 may store information in the form of static and/or dynamic information. The memory 112 may, for example, at least temporarily store and/or buffer fragments of metadata and/or media data retrieved by the media content consumer 102 from the server 104. This stored information may be stored and/or used by the media playback circuitry 118 during the course of performing its functionalities.

The communication interface 114 may be embodied as any device or means embodied in circuitry, hardware, a computer program product comprising computer readable program instructions stored on a computer readable medium (e.g., the memory 112) and executed by a processing device (e.g., the processor 110), or a combination thereof that is configured to receive and/or transmit data from/to another entity, such as, for example, a server 104. In at least one embodiment, the communication interface 114 is at least partially embodied as or otherwise controlled by the processor 110. In this regard, the communication interface 114 may be in communication with the processor 110, such as via a bus. The communication interface 114 may include, for example, an antenna, a transmitter, a receiver, a transceiver and/or supporting hardware or software for enabling communications with a server 104 or other network entity. The communication interface 114 may be configured to receive and/or transmit data using any protocol that may be used for communications with the server 104 over the network 108. The communication interface 114 may additionally be in communication with the memory 112, user interface 116, and/or media playback circuitry 118, such as via a bus.

The user interface 116 may be in communication with the processor 110 to receive an indication of a user input and/or to provide an audible, visual, mechanical, or other output to a user. As such, the user interface 116 may include, for example, a keyboard, a mouse, a joystick, a display, a touch screen display, a microphone, a speaker, and/or other input/output mechanisms. The user interface 116 may be in communication with the memory 112, communication interface 114, and/or media playback circuitry 118, such as via a bus.

The media playback circuitry 118 may be embodied as various means, such as circuitry, hardware, a computer program product comprising computer readable program instructions stored on a computer readable medium (e.g., the memory 112) and executed by a processing device (e.g., the processor 110), or some combination thereof and, in one embodiment, is embodied as or otherwise controlled by the processor 110. In embodiments wherein the media playback circuitry 118 is embodied separately from the processor 110, the media playback circuitry 118 may be in communication with the processor 110. The media playback circuitry 118 may further be in communication with one or more of the memory 112, communication interface 114, or user interface 116, such as via a bus.

The server 104 may comprise one or more computing devices configured to provide media files to a media content consumer 102. The one or more computing devices comprising the server 104 may comprise, for example, one or more content provider servers, network servers, network web servers, streaming servers, web servers network nodes, any combination thereof, and/or the like. It will be appreciated, however, that the aforementioned types of computing devices that may comprise the server 104 are provided merely for purposes of example and not by way of limitation. In this regard, the server 104 may be embodied as any computing device and/or combination of any plurality of computing devices and although referred to as a “server,” is not limited to being embodied as a server. In an exemplary embodiment, the server 104 includes various means, such as a processor 120, memory 122, communication interface 124, user interface 126, and media streaming circuitry 128 for performing the various functions herein described. These means of the server 104 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 122) that is executable by a suitably configured processing device (e.g., the processor 120), or some combination thereof.

The processor 120 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 1 as a single processor, in some embodiments the processor 120 comprises a plurality of processors. The plurality of processors may be in operative communication with each other and may be collectively configured to perform one or more functionalities of the server 104 as described herein. The plurality of processors may be embodied on a single computing device or may be distributed across a plurality of computing devices collectively configured to provide one or more functionalities of the server 104 as described herein. In an exemplary embodiment, the processor 120 is configured to execute instructions stored in the memory 122 or otherwise accessible to the processor 120. These instructions, when executed by the processor 120, may cause the server 104 to perform one or more of the functionalities of the server 104 as described herein. As such, whether configured by hardware or software methods, or by a combination thereof, the processor 120 may comprise an entity capable of performing operations according to embodiments of the present invention while configured accordingly. Thus, for example, when the processor 120 is embodied as an ASIC, FPGA or the like, the processor 120 may comprise specifically configured hardware for conducting one or more operations described herein. Alternatively, as another example, when the processor 120 is embodied as an executor of instructions, such as may be stored in the memory 122, the instructions may specifically configure the processor 120 to perform one or more algorithms and operations described herein.

The memory 122 may include, for example, volatile and/or non-volatile memory. Although illustrated in FIG. 1 as a single memory, the memory 122 may comprise a plurality of memories. The plurality of memories may be embodied on a single computing device or distributed across a plurality of computing devices collectively configured to function as a server 104. The memory 122 may comprise volatile memory, non-volatile memory, or some combination thereof. In this regard, the memory 122 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. The memory 122 may be configured to store information, data, applications, instructions, or the like for enabling the server 104 to carry out various functions in accordance with exemplary embodiments of the present invention. For example, in at least some embodiments, the memory 122 is configured to buffer input data for processing by the processor 120. Additionally or alternatively, in at least some embodiments, the memory 122 is configured to store program instructions for execution by the processor 120. The memory 122 may store information in the form of static and/or dynamic information. The memory 122 may, for example, be configured to store media files and metadata files describing respective media files. This stored information may be stored and/or used by the media streaming circuitry 128 during the course of performing its functionalities.

The communication interface 124 may be embodied as any device or means embodied in circuitry, hardware, a computer program product comprising computer readable program instructions stored on a computer readable medium (e.g., the memory 122) and executed by a processing device (e.g., the processor 120), or a combination thereof that is configured to receive and/or transmit data from/to another entity, such as, for example, a media content consumer 102. In at least one embodiment, the communication interface 124 is at least partially embodied as or otherwise controlled by the processor 120. In this regard, the communication interface 124 may be in communication with the processor 120, such as via a bus. The communication interface 124 may include, for example, an antenna, a transmitter, a receiver, a transceiver and/or supporting hardware or software for enabling communications with a media content consumer 102 or other network entity (e.g., via the network 108). The communication interface 124 may be configured to receive and/or transmit data using any protocol that may be used for communications with the media content consumer 102 over the network 108. The communication interface 124 may additionally be in communication with the memory 122, user interface 126, and/or media streaming circuitry 128, such as via a bus.

The user interface 126 may be in communication with the processor 120 to receive an indication of a user input and/or to provide an audible, visual, mechanical, or other output to a user. As such, the user interface 126 may include, for example, a keyboard, a mouse, a joystick, a display, a touch screen display, a microphone, a speaker, and/or other input/output mechanisms. In embodiments wherein the server is embodied as one or more servers, aspects of the user interface 126 may be reduced or the user interface 126 may even be eliminated. The user interface 126 may be in communication with the memory 122, communication interface 124, and/or media streaming circuitry 128, such as via a bus.

The media streaming circuitry 128 may be embodied as various means, such as circuitry, hardware, a computer program product comprising computer readable program instructions stored on a computer readable medium (e.g., the memory 122) and executed by a processing device (e.g., the processor 120), or some combination thereof and, in one embodiment, is embodied as or otherwise controlled by the processor 120. In embodiments wherein the media streaming circuitry 128 is embodied separately from the processor 120, the media streaming circuitry 128 may be in communication with the processor 120. The media streaming circuitry 128 may further be in communication with one or more of the memory 122, communication interface 124, or user interface 126, such as via a bus.

In some embodiments, the media streaming circuitry 128 is configured to structure and store media content in a format to support embodiments of the invention. In this regard, the media streaming circuitry 128 may be configured to format and store (e.g., in the memory 122) media content as two or more distinct, but related files. A first file according to such embodiments comprises a metadata file. The metadata file may be an ISOFF-compliant file comprising only metadata boxes. In this regard, the metadata file comprises only metadata, at least some of which describes media data (e.g. the actual video and/or audio data played back by a media content consumer 102) of an external media file, but does not itself comprise any media data. The metadata file may be arranged as a plurality of fragments to enable faster retrieval by the media content consumer 102. A second file of such embodiments comprises the media file, which is described by metadata of the metadata file. The media file is comprised of a plurality of contiguous fragments (also referred to as “chunks”) of media data. The fragments may comprise a predefined duration (e.g., a duration of a predefined number of seconds). The metadata of the metadata file may index the fragments of the media data of the media data file (e.g., through use of time offsets, byte offsets, and/or the like). It will be appreciated, however, that the media streaming circuitry 128 is not limited to structuring and storing media content as two files, but may store media content as more than two files so long as media data is separated from the metadata into distinct files. In this regard, the media streaming circuitry 128 may structure and store media data for a single piece of media content as two or more media files and/or may structure and store metadata for a single piece of media content as two or more metadata files.

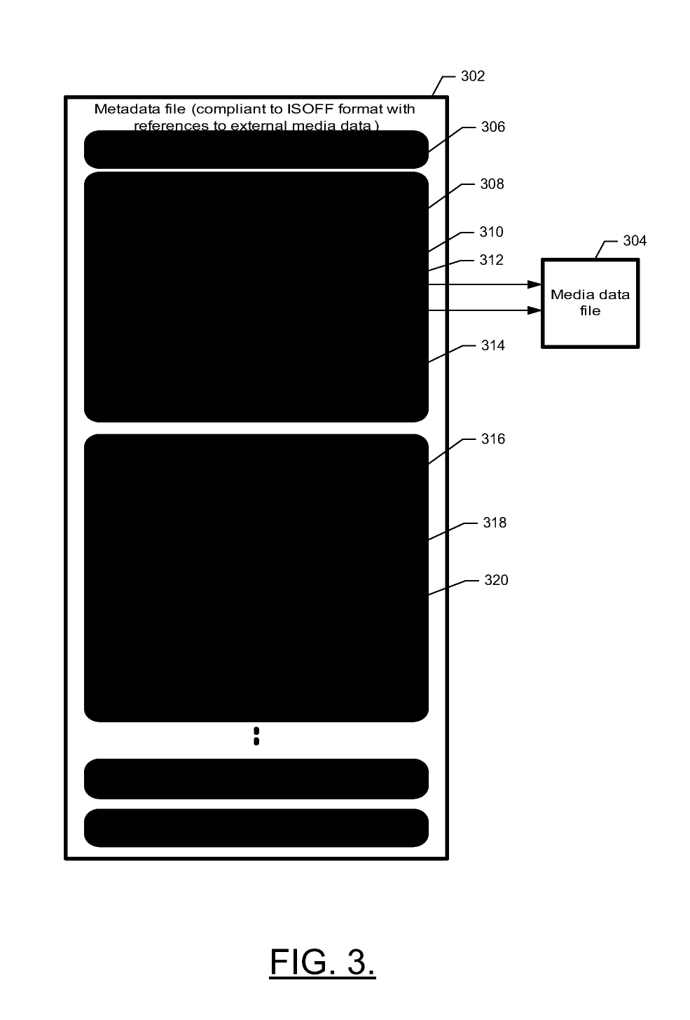

FIG. 3 illustrates ISOFF-compliant structured media content that may be formatted by the media streaming circuitry 128 in accordance with one example embodiment of the invention. In this regard, the media content illustrated in FIG. 3 is structured for static HTTP streaming in accordance with embodiments of the invention. It will be appreciated, however, that ISOFF-compliant media files are used for purposes of example and not by way of limitation. Further, the structure of the media content illustrated in FIG. 3 and described in respect thereto is for purposes of example and the structure may be arranged differently in accordance with other embodiments of the invention. Additionally, the media content of FIG. 3 is described with respect to movie content. However, it will be appreciated that embodiments of the invention may be applied to other types of media content as well, such as audio only media content, video only media content, and audio/video media content.

The media content of this embodiment is stored as a metadata file 302 and one or more media data files (e.g., media file) 304. The metadata file 302 of this embodiment comprises an ftyp box 306. The ftyp box is the first box in the metadata file 302 and comprises information about the brand and version number of the media content. The moov box 308 comprises information about the structure of the media data file 304. The moov box 308 comprises one or more track boxes 310, which describe the different media tracks that are described by the metadata file 302. The track boxes 310 further comprise information about the codecs and formats of the media described by the track. The track boxes 310 may not comprise a description of the samples themselves, however, so as to keep the box relatively small in size. The track boxes 310 also comprise dref boxes 312, which include a reference to the media data file 304 that contains samples for the track.

The metadata file 302 of this embodiment further comprises an mvex box 314, which holds default values for the subsequent movie fragment boxes and indicates that movie fragments are used. The moof box 316 comprises metadata that describes the samples of a movie fragment. The moof box 316 is structured as a plurality of traf boxes 318, which describe specific tracks of the movie. The traf boxes 318 comprise a trun box 320, which describes the media data fragments in track runs. Offsets are provided to point to the specific media data fragment in the referenced media data file 304.

When the media content consumer 102 (e.g., in response to a user request) wishes to consume (e.g., view, listen to, or otherwise playback) media content stored at the server 304, the media playback circuitry 118 is configured to cause the media content consumer 102 to establish a first communication channel with the server 104. The first communication channel may comprise a transport layer protocol communication channel, such as, for example, a TCP communication channel. Establishment of the first communication channel may be performed in accordance with protocol standards and the media streaming circuitry 128 may be configured to facilitate establishment of the first communication channel at the server 104.

After the first communication channel has been established, the media playback circuitry 118 is configured in some embodiments to retrieve, by the first communication channel, at least a portion a metadata file for the desired media content. In this regard, the media playback circuitry 118 may be configured to format a request, such as, for example, a transfer protocol GET request (e.g., an HTTP GET request), requesting at least a portion of the metadata file and cause the request to be transmitted to the server 104. The media streaming circuitry 128 may receive the request and then provide the requested at least a portion of the metadata file to the media content consumer 102, where it may be received by the media playback circuitry 118. The media playback circuitry 118 may be configured to retrieve the at least a portion of the metadata file as a series of fragments (e.g., by progressive download), as metadata streamed to the media content consumer 102 by the media streaming circuitry 128, and/or the like. In further example embodiments, the media playback circuitry 118 may be configured to retrieve the at least a portion of the metadata file as a byte stream, using HTTP chunked transfer mode, and/or the like. The metadata may be streamed/retrieved throughout a playback period of media data referenced/described by the metadata file (e.g., until all of the metadata has been retrieved), entirely before a playback period of media data referenced/described by the metadata file, through a first portion of a playback period media data referenced/described by the metadata file, partially before a start of a playback period of media data referenced/described by the metadata file and partially after the start of the playback period, and/or the like.

After the media playback circuitry 118 has retrieved the at least a portion of the metadata file, the media playback circuitry 118 may be configured to parse the metadata. The media playback circuitry 118 may be configured to determine from the parsed metadata whether the metadata file is configured for static transport protocol streaming, such as based upon the brand and/or type of the metadata file. If the metadata file is not configured for static transport protocol streaming, the media playback circuitry 118 may be configured to retrieve the media data content by other means, such as, for example, progressive download.

The media playback circuitry 118 is configured in some embodiments to parse the metadata of the retrieved at least a portion of the metadata file to determine a desired portion(s) (e.g., fragments or a set of media samples) of the media data content of a media data file. In this regard, the media playback circuitry 118 may be configured to determine offset information for the desired portion based at least in part upon indexing information included in the retrieved metadata. If the media content comprises media data in multiple audio languages, video qualities, and/or the like, the media playback circuitry 118 may be configured to parse and analyze the metadata to determine media data portions corresponding to the desired video quality, audio language, and/or the like.

The media playback circuitry 118 is configured in some embodiments of the invention to further cause the media content consumer 102 to establish a second communication channel with the server 104. The second communication channel may comprise a transport layer protocol communication channel, such as, for example, a TCP communication channel. Establishment of the second communication channel may be performed in accordance with protocol standards and the media streaming circuitry 128 may be configured to facilitate establishment of the second communication channel at the server 104.

The media playback circuitry 118 is additionally configured in accordance with embodiments of the invention to retrieve, by the second communication channel, at least a portion of the media file as determined from the retrieved at least a portion of the metadata file. In this regard, the media playback circuitry 118 may be configured to format a request, such as, for example, a transfer protocol GET request (e.g., an HTTP GET request), comprising an indication of the requested portion of the media file. The indication of the requested portion of the media file may comprise offset information defining one or more requested fragments of the media file as determined from parsing the retrieved metadata. The media playback circuitry 118 may then cause the request to be transmitted to the server 104, where it may be received by the media streaming circuitry 128. The media streaming circuitry 128 may then provide the requested portion of the media file to the media content consumer 102. Upon receipt of the media data, the media playback circuitry 118 may begin playback of the retrieved media data.

In some embodiments of the invention, the media playback circuitry 118 is configured to format a request for multiple fragments of the media file. The media streaming circuitry 128 may consequently be configured to receive and respond to a request for multiple fragments of the media file. In this regard, the request formatted by the media playback circuitry 118 may comprise, for example, an indication of a starting offset and ending offset for a portion of the media file that may span multiple fragments. Such requests for multiple fragments may reduce the overhead and network traffic required by previous streaming conventions that limited requests to a single fragment at a time.

In some embodiments, the media playback circuitry 118 is configured to apply a seek operation in a media content stream being played back. A seek operation comprises modifying the playback time to a different point of time selected, for example, by a user. In order to perform a seek operation, the media playback circuitry 118 may be configured to locate the appropriate position in the metadata file comprising the metadata fragment that describes the related media data for the requested point in the media timeline. The media playback circuitry 118 may be configured to locate the position based at least in part upon a box location within the metadata file. For example, the metadata file may have fixed size “moof' and “mfra” boxes that refer to fixed duration portions of the media data and that contain a fixed size of media samples. Consequently, the media playback circuitry 118 may be configured to locate the position of the required metadata fragment based at least in part on the fragment duration and the size of each metadata fragment and the requested start time. The media playback circuitry 118 may then determine appropriate offset(s) from the metadata fragment(s) and retrieve the appropriate media data (e.g., for the appropriate time position), such as for example, by sending a GET request with the calculated starting byte. The media playback circuitry 118 may then verify that the first bytes of the response correspond to the moof box header.

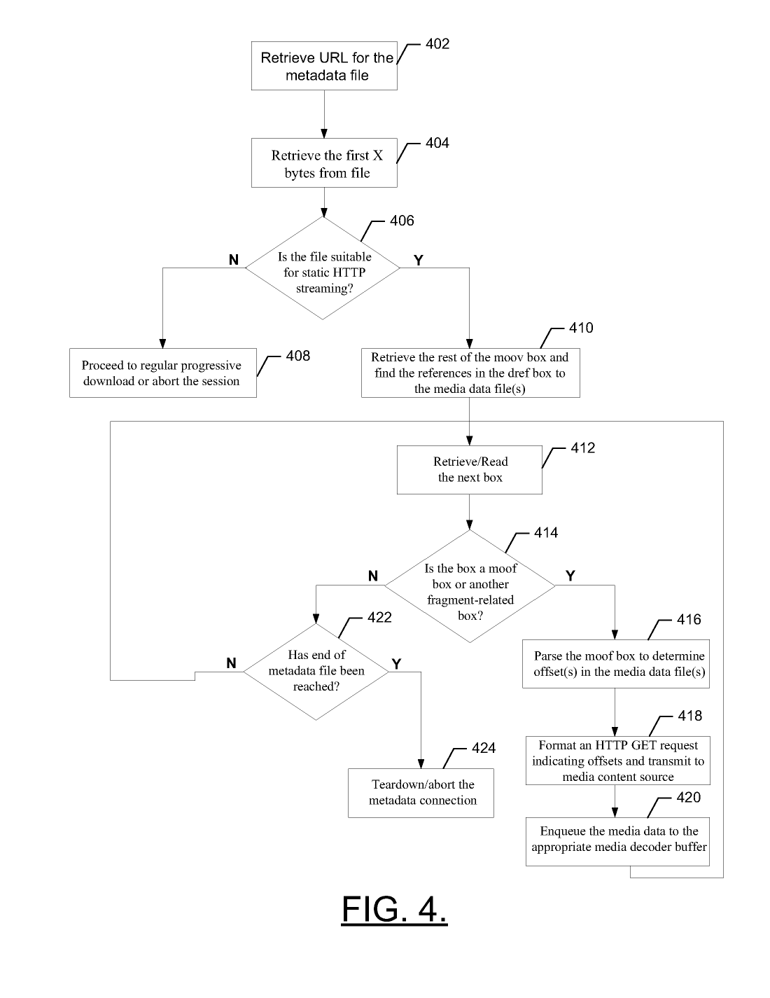

FIG. 4 illustrates a flowchart according to an exemplary method for facilitating streaming of media files according to an exemplary embodiment of the present invention. In this regard, FIG. 4 illustrates an example method for facilitating static HTTP streaming when the metadata file for the media content to be streamed is formatted as an ISOFF-compliant file in accordance with one embodiment of the invention. The operations illustrated in FIG. 4 may be performed at and/or by the media content consumer 102. In this regard, at least some of the operations illustrated in and described with respect to FIG. 4 may, for example, be performed by or under the control of the media playback circuitry 118.

Operation 402 comprises retrieving the URL to the metadata file for the media content from a web site or through other means. The media playback circuitry 118 recognizes that the metadata file is an ISOFF base file format (e.g. a Third Generation Partnership (3GP) file format) and attempts to play it using HTTP streaming. The media playback circuitry 118 establishes a first TCP communication channel to the server 104 that is located by the content URL. Operation 404 comprises retrieving a first portion of the metadata file that include the ftyp box and size and type indication of the subsequent box over a first communication channel This first portion comprises the first few bytes (typically approximately 16-32 bytes) of the metadata file. Operation 406 comprises determining based on the retrieved first portion whether the metadata file is suitable for static HTTP streaming. This determination may be made based on the file brand information indicated in the retrieved first portion.

If the metadata file is not suitable for static HTTP streaming (e.g., if the file brand does not match a defined brand for static HTTP streaming), operation 408 comprises proceeding with regular HTTP progressive download or abandoning the content session. If, however, it is determined in operation 406 that the metadata file is suitable for static HTTP streaming, operation 410 comprises retrieving any non-retrieved portion of the moov box and finding the references in the dref box to the media data file(s). Operation 410 may further comprise parsing the moov box to identify the number of tracks, their media types, the required media codecs, the bitrates, and/or the like for the media data of the media file(s). If an mvex box is not found to be contained within the moov box the download may be abandoned or the media content consumer may revert to regular progressive download.

After parsing the moov box, operation 412 comprises retrieving (if not already retrieved) and reading the next box. It will be appreciated that when a retrieving operation is performed at operation 412 (e.g., if the next box has not already been retrieved), the retrieval operation may retrieve a single box or multiple boxes in a request. Operation 414 comprises and determining whether the box read in operation 412 is a moof box or another fragment related box.

When it is determined in operation 412 that the box is a moof box, operation 416 comprises parsing the moof box to determine offset(s) in the media data file(s). In this regard, operation 416 may comprise extracting the references to the media fragments of the media tracks that the media content consumer 102 wants to playout (e.g., tracks having a appropriate bit rate, audio language, media codec, and/or the like) as offsets in the media data file(s). Operation 418 then comprises formatting an HTTP GET request indicating offset(s) (e.g., time offsets, byte offsets, or the like) for the desired media data fragments and transmitting the request to the server 104 for retrieval of media data over a second communication channel. In this regard, operation 418 may comprise formatting a GET request using the URL that is present in the dref box of a desired track and setting the “Content-Range” header of the HTTP/1.1 request to the appropriate offset and total sample sizes. Operation 420 comprises receiving the requested media data fragments and enqueueing the received media data to an appropriate media decoder buffer for decoding and playback. The method may then return to operation 412 by which the next box of the metadata file will be read.

If, however, it was determined at operation 414 that the box was not a moof box, operation 422 comprises determining whether the end of the metadata file has been reached. If the end of the metadata file has not been reached, the method returns to operation 412 by which the next box of the metadata file will be read. If, however, the end of the metadata file has been reached, operation 424 comprises tearing down/aborting the metadata communication channel (i.e., the first communication channel).

Although the downloading of the metadata file is described with respect to FIG. 4 as downloading the metadata file in a piecemeal fashion, it will be appreciated that the media content consumer 102 may download the whole metadata file in alternative scenarios, such as, if the size of the metadata file is not known a-priori. When the media content consumer 102 downloads the whole metadata file, the server 104 may deliver the metadata file using the HTTP 1.1 chunked mode.

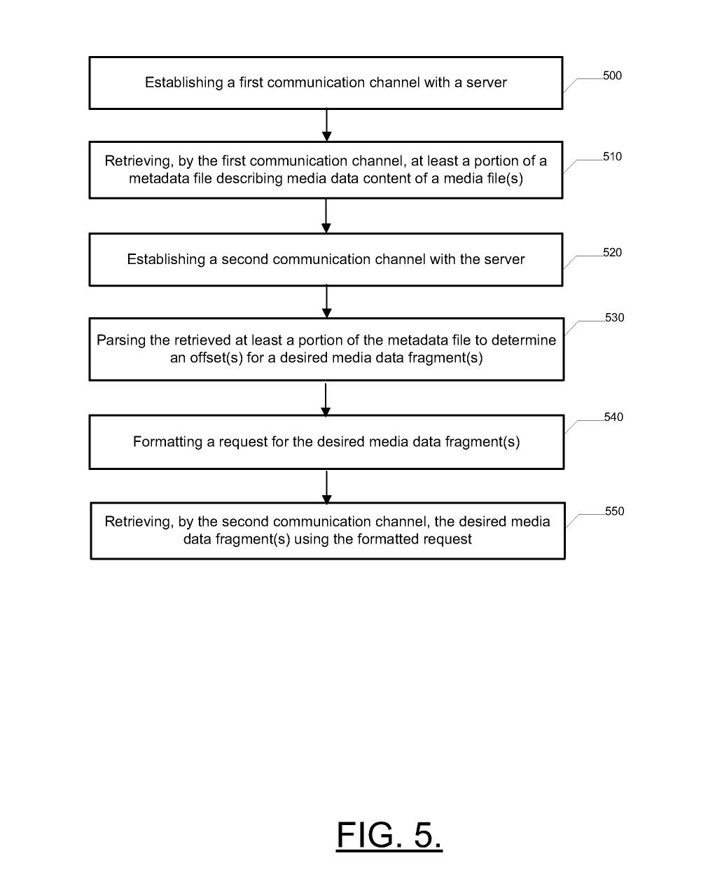

FIG. 5 illustrates a flowchart according to an exemplary method for facilitating streaming of media files according to an exemplary embodiment of the present invention. In this regard, FIG. 5 illustrates operations that may be performed at a media content consumer 102. The operations illustrated in and described with respect to FIG. 5 may, for example, be performed by or under the control of the media playback circuitry 118. Operation 500 comprises establishing a first communication channel with a server 104. The method further comprises retrieving, by the first communication channel, at least a portion of a metadata file describing media data content of a media file(s), at operation 510. Operation 520 comprises establishing a second communication channel with the server. The method additionally comprises parsing the retrieved at least a portion of the metadata file to determine an offset(s) for a desired media data fragment(s), at operation 530. Operation 540 comprises formatting a request for the desired media data fragment(s). The method also comprises retrieving, by the second communication channel, the desired media data fragment(s) using the formatted request, at operation 550. It will be appreciated that the ordering of operation 520 is for purposes of example and not by way of limitation. In this regard, the second communication channel may be established at any point prior to retrieval of the media data fragment(s), and may, for example, be established concurrently with the first communication channel at operation 500.

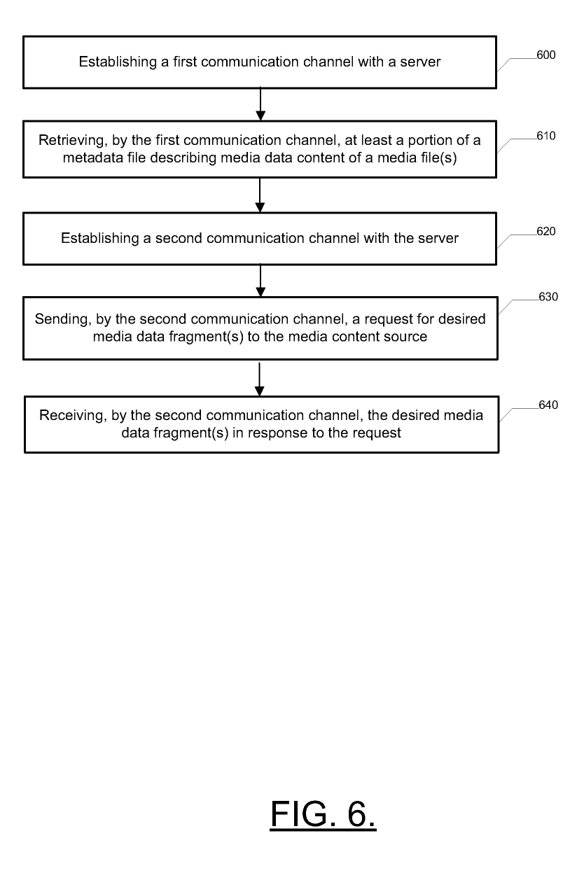

FIG. 6 illustrates a flowchart according to an exemplary method for facilitating streaming of media files according to an exemplary embodiment of the present invention. In this regard, FIG. 6 illustrates operations that may be performed by a media content consumer 102. One or more of the processor 110, memory 112, communication interface 114, user interface 116, or media playback circuitry 118 may, for example, cause the media content consumer 102 to perform respective operations illustrated in and described with respect to FIG. 6. Operation 600 comprises establishing a first communication channel with a server 104. The method further comprises retrieving, by the first communication channel, at least a portion of a metadata file describing media data content of a media file(s), at operation 610. Operation 620 comprises establishing a second communication channel with the server. The method also comprises sending, by the second communication channel, a request for desired media data fragment(s) to the server 104, at operation 630. Operation 640 comprises receiving, by the second communication channel, the desired media data fragment(s) in response to the request. It will be appreciated that the ordering of operation 620 is for purposes of example and not by way of limitation. In this regard, the second communication channel may be established at any point prior to operation 630, and may, for example, be established concurrently with the first communication channel at operation 600.

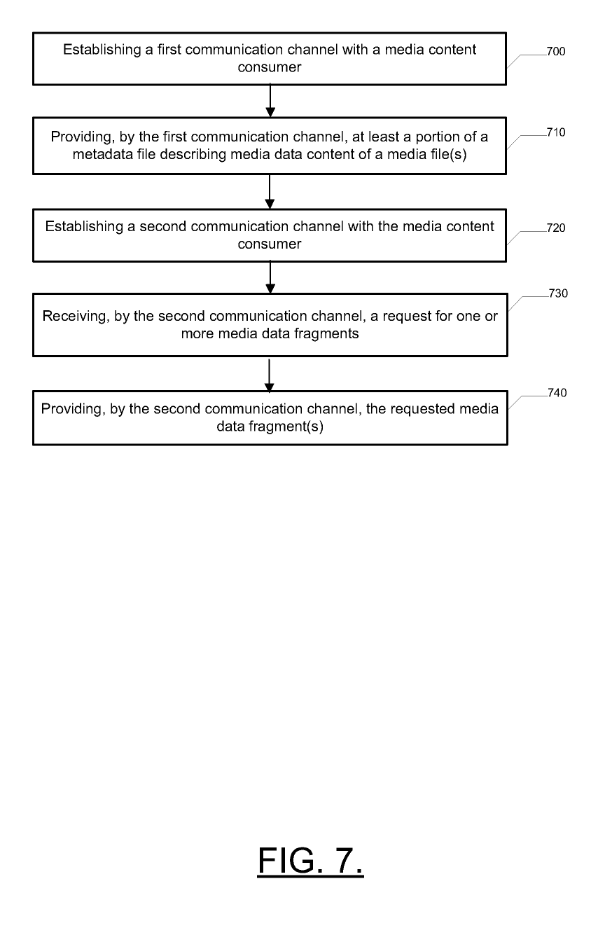

FIG. 7 illustrates a flowchart according to an exemplary method for facilitating streaming of media files according to an exemplary embodiment of the present invention. In this regard, FIG. 7 illustrates operations that may be performed at a server 104. The operations illustrated in and described with respect to FIG. 7 may, for example, be performed by or under the control of the media streaming circuitry 128. Operation 700 comprises establishing a first communication channel with a media content consumer 102. The method further comprises providing, by the first communication channel, at least a portion of a metadata file describing media data content of a media file(s), at operation 710. Operation 720 comprises establishing a second communication channel with the media content consumer 102. The method additionally comprises receiving, by the second communication channel a request for one or more media data fragments, at operation 730. Operation 740 comprises providing, by the second communication channel, the requested media data fragment(s). It will be appreciated that the ordering of operation 720 is for purposes of example and not by way of limitation. In this regard, the second communication channel may be established at any point prior to operation 730, and may, for example, be established concurrently with the first communication channel at operation 700.

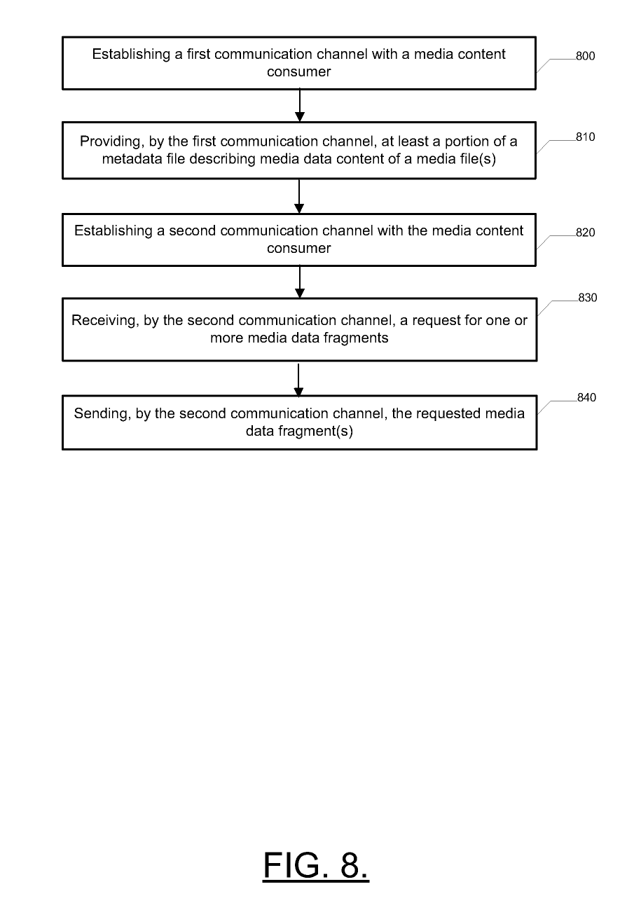

FIG. 8 illustrates a flowchart according to an exemplary method for facilitating streaming of media files according to an exemplary embodiment of the present invention. In this regard, FIG. 8 illustrates operations that may be performed by a server 104. One or more of the processor 120, memory 122, communication interface 124, user interface 126, or media streaming circuitry 128 may, for example, cause the server 104 to perform respective operations illustrated in and described with respect to FIG. 8. Operation 800 comprises establishing a first communication channel with a media content consumer 102. The method further includes providing, by the first communication channel, at least a portion of a metadata file describing media data content of a media file(s), at operation 810. Operation 820 comprises establishing a second communication channel with the media content consumer. The method also includes receiving, by the second communication channel, a request for one or more media data fragments, at operation 830. Operation 840 comprises sending, by the second communication channel, the requested media data fragment(s). It will be appreciated that the ordering of operation 820 is for purposes of example and not by way of limitation. In this regard, the second communication channel may be established at any point prior to operation 830, and may, for example, be established concurrently with the first communication channel at operation 800.

FIGS. 4-8 are flowcharts of systems, methods, and computer program products according to exemplary embodiments of the invention. It will be understood that each block or step of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device and executed by a processor (e.g., a processor 110 or processor 120) in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s) or step(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s) or step(s). The computer program instructions of one or more computer program products may also be loaded onto a computer or other programmable apparatus (e.g., a media content consumer 102 and/or server 104) to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions and combinations of steps for performing the specified functions. It will also be understood that one or more blocks or steps of the flowchart, and combinations of blocks or steps in the flowchart, may be implemented by special purpose hardware-based computer systems which perform the specified functions or steps, or combinations of special purpose hardware and computer program product(s).

The above described functions may be carried out in many ways. For example, any suitable means for carrying out each of the functions described above may be employed to carry out embodiments of the invention. In one embodiment, a suitably configured processor may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

In a first example embodiment, a method is provided, which comprises establishing a first communication channel with a server. The method of this embodiment further comprises retrieving, by the first communication channel, at least a portion of a metadata file describing media data content of a media file. The method of this embodiment additionally comprises establishing a second communication channel with the server. The method of this embodiment also comprises retrieving, by the second communication channel, at least a portion of the media file based at least in part upon the retrieved at least a portion of the metadata file.

The at least a portion of the metadata file of this embodiment may comprise indexing information for media data fragments comprising the media file. The fragments comprising the media file may each have a predefined duration. The method of this embodiment may further comprise parsing the at least a portion of the metadata file to determine an offset for at least one media data fragment based at least in part upon the indexing information. Retrieving the at least a portion of the media file may comprise using the determined offset to retrieve at least one media data fragment from the media file. Retrieving the at least a portion of the media file may comprise retrieving at least a portion of the media file by way of a request transmitted to the server comprising offset information defining at least one media data fragment for retrieval.

Retrieving the at least a portion of the metadata file may comprise retrieving the at least a portion of the metadata file as a series of fragments, as a byte stream, using HTTP chunked transfer mode, or by streaming

The method of this embodiment may further comprise determining whether the metadata file is configured for static transport protocol streaming. Retrieving the at least a portion of the media file may comprise retrieving the at least a portion of the media file when it is determined that the metadata file is configured for static transport protocol streaming Determining whether the metadata file is configured for static transport protocol streaming may comprise analyzing a first portion of the metadata file to determine whether the file brand comprises a brand configured for static transport protocol streaming.

The metadata file of this embodiment may comprise an ISOFF (International Organization for Standardization (ISO) base media file format) compliant file. The ISOFF-compliant metadata file may comprise only metadata boxes without any media data. The metadata file may comprise indexing information indexing fragments of media data in the media file. The metadata file may be arranged as a plurality of fragments to enable a faster rate of retrieval.

The first and second communication channels of this embodiment may comprise transport layer protocol communication channels. The transport layer protocol communication channels may comprise transmission control protocol communication channels. Retrieving the at least a portion of the metadata may comprise retrieving the at least a portion of the metadata file using a transfer protocol. The transfer protocol may comprise hypertext transfer protocol. Retrieving the at least a portion of the media file may comprise retrieving the at least a portion of the media file using a transfer protocol. The transfer protocol may comprise hypertext transfer protocol.

Retrieving the at least a portion of the media file using a transfer protocol may comprise formatting a transfer protocol GET request comprising an indication of a requested portion of the media file. The indication of the requested portion of the media file may comprise offset information defining one or more requested fragments of the media file. Retrieving the at least a portion of the media file using a transfer protocol may further comprise causing the transfer protocol GET request to be transmitted to the server. Retrieving the at least a portion of the media file using a transfer protocol may additionally comprise receiving the requested portion of the media file in response to the transfer protocol GET request.

In an embodiment, the content consuming device may apply a seek operation in the stream being played back. A seek operation comprises modifying the playback time to a different point of time selected, for example, by the user. In order to perform a seek operation, the method of this embodiment may further comprise locating the appropriate position in the metadata file that locates the metadata fragment that describes the related media data for the requested point in the media timeline. This may be achieved by having fixed size “moof' and “mfra” boxes that refer to a fixed duration portions of the media data and that contain a fixed size of media samples. As a result, the media data consumer device may locate the position of the required metadata fragment based on the fragment duration and the size of each metadata fragment and the requested start time. The media data consumer device may then seek in the metadata file the appropriate position by sending a GET request with the calculated starting byte. The media data consumer device may verify that the first bytes of the response correspond to the moof box header.

In another example embodiment, an apparatus is provided. The apparatus of this embodiment comprises at least one processor and at least one memory storing computer program code, wherein the at least one memory and stored computer program code are configured to, working with the at least one processor, cause the apparatus to at least establish a first communication channel with a server. The at least one memory and stored computer program code are configured to, working with the at least one processor, further cause the apparatus of this embodiment to retrieve, by the first communication channel, at least a portion of a metadata file describing media data content of a media file. The at least one memory and stored computer program code are configured to, working with the at least one processor, additionally cause the apparatus of this embodiment to establish a second communication channel with the server. The at least one memory and stored computer program code are configured to, working with the at least one processor, also cause the apparatus of this embodiment to retrieve, by the second communication channel, at least a portion of the media file based at least in part upon the retrieved at least a portion of the metadata file.

The at least a portion of the metadata file of this embodiment may comprise indexing information for media data fragments comprising the media file. The fragments comprising the media file may each have a predefined duration. The at least one memory and stored computer program code may be configured to, working with the at least one processor, further cause the apparatus of this embodiment to parse the at least a portion of the metadata file to determine an offset for at least one media data fragment based at least in part upon the indexing information. The at least one memory and stored computer program code may be configured to, working with the at least one processor, cause the apparatus of this embodiment to retrieve the at least a portion of the media file by using the determined offset to retrieve at least one media data fragment from the media file. The at least one memory and stored computer program code may be configured to, working with the at least one processor, cause the apparatus of this embodiment to retrieve the at least a portion of the media file by retrieving at least a portion of the media file by way of a request transmitted to the server comprising offset information defining at least one media data fragment for retrieval.

The at least one memory and stored computer program code may be configured to, working with the at least one processor, cause the apparatus of this embodiment to retrieve the at least a portion of the metadata file by retrieving the at least a portion of the metadata file as a series of fragments, as a byte stream, using HTTP chunked transfer mode, or by streaming.

The at least one memory and stored computer program code may be configured to, working with the at least one processor, further cause the apparatus of this embodiment to determine whether the metadata file is configured for static transport protocol streaming The at least one memory and stored computer program code may be configured to, working with the at least one processor, cause the apparatus of this embodiment to retrieve the at least a portion of the media file by retrieving the at least a portion of the media file when it is determined that the metadata file is configured for static transport protocol streaming The at least one memory and stored computer program code may be configured to, working with the at least one processor, cause the apparatus of this embodiment to determine whether the metadata file is configured for static transport protocol streaming by analyzing a first portion of the metadata file to determine whether the file brand comprises a brand configured for static transport protocol streaming.

The metadata file of this embodiment may comprise an ISOFF (International Organization for Standardization (ISO) base media file format) compliant file. The ISOFF-compliant metadata file may comprise only metadata boxes without any media data. The metadata file may comprise indexing information indexing fragments of media data in the media file. The metadata file may be arranged as a plurality of fragments to enable a faster rate of retrieval.

The first and second communication channels of this embodiment may comprise transport layer protocol communication channels. The transport layer protocol communication channels may comprise transmission control protocol communication channels. The at least one memory and stored computer program code may be configured to, working with the at least one processor, cause the apparatus of this embodiment to retrieve the at least a portion of the metadata by retrieving the at least a portion of the metadata file using a transfer protocol. The transfer protocol may comprise hypertext transfer protocol. The at least one memory and stored computer program code may be configured to, working with the at least one processor, cause the apparatus of this embodiment to retrieve the at least a portion of the media file by retrieving the at least a portion of the media file using a transfer protocol. The transfer protocol may comprise hypertext transfer protocol.

The at least one memory and stored computer program code may be configured to, working with the at least one processor, further cause the apparatus of this embodiment to format a transfer protocol GET request comprising an indication of a requested portion of the media file. The indication of the requested portion of the media file may comprise offset information defining one or more requested fragments of the media file. The at least one memory and stored computer program code may be configured to, working with the at least one processor, cause the apparatus of this embodiment to retrieve the at least a portion of the media file using a transfer protocol by causing the transfer protocol GET request to be transmitted to the server. The at least one memory and stored computer program code may be configured to, working with the at least one processor, further cause the apparatus of this embodiment to receive the requested portion of the media file in response to the transfer protocol GET request.

The apparatus of this embodiment may be embodied as or may be embodied on a terminal The apparatus of this embodiment may comprise a mobile phone further comprising user interface circuitry and user interface software stored on one or more of the at least one memory. The user interface circuitry and user interface software may be configured to facilitate user control of at least some functions of the mobile phone through use of a display. The user interface circuitry and user interface software may be further configured to cause at least a portion of a user interface of the mobile phone to be displayed on the display to facilitate user control of at least some functions of the mobile phone.

The at least one memory and stored computer program code may be configured to, working with the at least one processor, further cause the apparatus of this embodiment to locate an appropriate position in the metadata file that locates the metadata fragment that describes the related media data for a requested point in the media timeline. This may be achieved by having fixed size “moof' and “mfra” boxes that refer to a fixed duration portions of the media data and that contain a fixed size of media samples. As a result, the apparatus may locate the position of the required metadata fragment based on the fragment duration and the size of each metadata fragment and the requested start time. The at least one memory and stored computer program code may be configured to, working with the at least one processor, further cause the apparatus to seek in the metadata file the appropriate position by sending a GET request with the calculated starting byte. The at least one memory and stored computer program code may be configured to, working with the at least one processor, further cause the apparatus to verify that the first bytes of the response correspond to the moof box header.

In another example embodiment, a computer program product is provided. The computer program product of this embodiment includes at least one computer-readable storage medium having computer-readable program instructions stored therein. The computer program product of this embodiment comprises program instructions configured, when executed by a processor, to cause an apparatus to establish a first communication channel with a server. The computer program product of this embodiment further comprises program instructions configured, when executed by a processor, to cause an apparatus to retrieve, by the first communication channel, at least a portion of a metadata file describing media data content of a media file. The computer program product of this embodiment additionally comprises program instructions configured, when executed by a processor, to cause an apparatus to establish a second communication channel with the server. The computer program product of this embodiment also comprises program instructions configured, when executed by a processor, to cause an apparatus to retrieve, by the second communication channel, at least a portion of the media file based at least in part upon the retrieved at least a portion of the metadata file.

The at least a portion of the metadata file of this embodiment may comprise indexing information for media data fragments comprising the media file. The fragments comprising the media file may each have a predefined duration. The computer program product of this embodiment may further comprise program instructions configured, when executed by a processor, to cause an apparatus to parse the at least a portion of the metadata file to determine an offset for at least one media data fragment based at least in part upon the indexing information. The program instructions configured to cause an apparatus to retrieve the at least a portion of the media file may comprise instructions configured, when executed by a processor, to cause an apparatus to use the determined offset to retrieve at least one media data fragment from the media file. The program instructions configured to cause an apparatus to retrieve the at least a portion of the media file may comprise instructions configured, when executed by a processor, to cause an apparatus to retrieve at least a portion of the media file by way of a request transmitted to the server comprising offset information defining at least one media data fragment for retrieval.

The program instructions configured to cause an apparatus to retrieve the at least a portion of the metadata file may comprise instructions configured, when executed by a processor, to cause an apparatus to retrieve the at least a portion of the metadata file as a series of fragments, as a byte stream, using HTTP chunked transfer mode, or by streaming.

The computer program product of this embodiment may further comprise program instructions configured, when executed by a processor, to cause an apparatus to determine whether the metadata file is configured for static transport protocol streaming. The program instructions configured to cause an apparatus to retrieve the at least a portion of the media file may comprise instructions configured, when executed by a processor, to cause an apparatus to retrieve the at least a portion of the media file when it is determined that the metadata file is configured for static transport protocol streaming. The program instructions configured to cause an apparatus to determine whether the metadata file is configured for static transport protocol streaming may comprise instructions configured, when executed by a processor, to cause an apparatus to analyze a first portion of the metadata file to determine whether the file brand comprises a brand configured for static transport protocol streaming

The metadata file of this embodiment may comprise an ISOFF (International Organization for Standardization (ISO) base media file format) compliant file. The ISOFF-compliant metadata file may comprise only metadata boxes without any media data. The metadata file may comprise indexing information indexing fragments of media data in the media file. The metadata file may be arranged as a plurality of fragments to enable a faster rate of retrieval.

The first and second communication channels of this embodiment may comprise transport layer protocol communication channels. The transport layer protocol communication channels may comprise transmission control protocol communication channels. The program instructions configured to cause an apparatus to retrieve the at least a portion of the metadata may comprise instructions configured, when executed by a processor, to cause an apparatus to retrieve the at least a portion of the metadata file using a transfer protocol. The transfer protocol may comprise hypertext transfer protocol. The program instructions configured to cause an apparatus to retrieve the at least a portion of the media file may comprise instructions configured, when executed by a processor, to cause an apparatus to retrieve the at least a portion of the media file using a transfer protocol. The transfer protocol may comprise hypertext transfer protocol.

The program instructions configured to cause an apparatus to retrieve the at least a portion of the media file using a transfer protocol may comprise instructions configured, when executed by a processor, to cause an apparatus to format a transfer protocol GET request comprising an indication of a requested portion of the media file. The indication of the requested portion of the media file may comprise offset information defining one or more requested fragments of the media file. The program instructions configured to cause an apparatus to retrieve the at least a portion of the media file using a transfer protocol may further comprise instructions configured, when executed by a processor, to cause an apparatus to transmit the transfer protocol GET request to the server. The program instructions configured to cause the apparatus to retrieve the at least a portion of the media file using a transfer protocol may additionally comprise instructions configured, when executed by a processor, to cause an apparatus to receive the requested portion of the media file in response to the transfer protocol GET request.

In another example embodiment, an apparatus is provided, which comprises means for establishing a first communication channel with a server. The apparatus of this embodiment further comprises means for retrieving, by the first communication channel, at least a portion of a metadata file describing media data content of a media file. The apparatus of this embodiment additionally comprises means for establishing a second communication channel with the server. The apparatus of this embodiment also comprises means for retrieving, by the second communication channel, at least a portion of the media file based at least in part upon the retrieved at least a portion of the metadata file.

In another example embodiment, a method is provided, which comprises establishing a first communication channel with a media content consumer. The method of this embodiment further comprises providing, by the first communication channel, at least a portion of a metadata file describing media data content of a media file. The method of this embodiment additionally comprises establishing a second communication channel with the media content consumer. The method of this embodiment also comprises providing, by the second communication channel, at least a portion of the media file, the provided at least a portion of the media file requested by the media content consumer based at least in part on information in the provided at least a portion of the metadata file.

Providing the at least a portion of the metadata file may comprise providing the at least a portion of the metadata file as a series of fragments or providing the at least a portion of the metadata file by streaming the metadata file to the media content consumer.

The at least a portion of the metadata file of this embodiment may comprise indexing information for media data fragments comprising the media file. The fragments comprising the media file may each have a predefined duration. The method of this embodiment may further comprise receiving a request transmitted by the media content consumer comprising offset information defining at least one media data fragment, wherein the offset information is determined by the media content consumer based at least in part on the indexing information. Providing the at least a portion of the media file may comprise providing the at least one media data fragment defined by the offset information included in the request.

The metadata file of this embodiment may comprise an ISOFF (International Organization for Standardization (ISO) base media file format) compliant file. The ISOFF-compliant metadata file may comprise only metadata boxes without any media data. The metadata file may comprise indexing information indexing fragments of media data in the media file. The metadata file may be arranged as a plurality of fragments.

The first and second communication channels of this embodiment may comprise transport layer protocol communication channels. The transport layer protocol communication channels may comprise transmission control protocol communication channels. Providing the at least a portion of the metadata may comprise providing the at least a portion of the metadata file using a transfer protocol. The transfer protocol may comprise hypertext transfer protocol. Providing the at least a portion of the media file may comprise providing the at least a portion of the media file using a transfer protocol. The transfer protocol may comprise hypertext transfer protocol.

The method of this embodiment may further comprise receiving a transfer protocol GET request transmitted by the media content consumer, the transfer protocol GET request comprising an indication of a requested portion of the media file. The indication of the requested portion of the media file may comprise offset information defining one or more requested fragments of the media file. Providing the at least a portion of the media file using a transfer protocol may comprise providing the requested portion of the media file to the media content consumer in response to the transfer protocol GET request.

In another example embodiment, an apparatus is provided. The apparatus of this embodiment comprises at least one processor and at least one memory storing computer program code, wherein the at least one memory and stored computer program code are configured to, working with the at least one processor, cause the apparatus to at least establish a first communication channel with a media content consumer. The at least one memory and stored computer program code are configured to, working with the at least one processor, further cause the apparatus of this embodiment to provide, by the first communication channel, at least a portion of a metadata file describing media data content of a media file. The at least one memory and stored computer program code are configured to, working with the at least one processor, also cause the apparatus of this embodiment to establish a second communication channel with the media content consumer. The at least one memory and stored computer program code are configured to, working with the at least one processor, additionally cause the apparatus of this embodiment to provide, by the second communication channel, at least a portion of the media file, the provided at least a portion of the media file requested by the media content consumer based at least in part on information in the provided at least a portion of the metadata file.

The at least one memory and stored computer program code may be configured to, working with the at least one processor, cause the apparatus of this embodiment to provide the at least a portion of the metadata file by providing the at least a portion of the metadata file as a series of fragments or by providing the at least a portion of the metadata file by streaming the metadata file to the media content consumer.

The at least a portion of the metadata file of this embodiment may comprise indexing information for media data fragments comprising the media file. The fragments comprising the media file may each have a predefined duration. The at least one memory and stored computer program code may be configured to, working with the at least one processor, further cause the apparatus of this embodiment to receive a request transmitted by the media content consumer, the request comprising offset information defining at least one media data fragment, wherein the offset information is determined by the media content consumer based at least in part on the indexing information. The at least one memory and stored computer program code may be configured to, working with the at least one processor, cause the apparatus of this embodiment to provide the at least a portion of the media file by providing the at least one media data fragment defined by the offset information included in the request.

The metadata file of this embodiment may comprise an ISOFF (International Organization for Standardization (ISO) base media file format) compliant file. The ISOFF-compliant metadata file may comprise only metadata boxes without any media data. The metadata file may comprise indexing information indexing fragments of media data in the media file. The metadata file may be arranged as a plurality of fragments.

The first and second communication channels of this embodiment may comprise transport layer protocol communication channels. The transport layer protocol communication channels may comprise transmission control protocol communication channels. The at least one memory and stored computer program code may be configured to, working with the at least one processor, cause the apparatus of this embodiment to provide the at least a portion of the metadata by providing the at least a portion of the metadata file using a transfer protocol. The transfer protocol may comprise hypertext transfer protocol. The at least one memory and stored computer program code may be configured to, working with the at least one processor, cause the apparatus of this embodiment to provide the at least a portion of the media file by providing the at least a portion of the media file using a transfer protocol. The transfer protocol may comprise hypertext transfer protocol.

The at least one memory and stored computer program code may be configured to, working with the at least one processor, further cause the apparatus of this embodiment to receive a transfer protocol GET request transmitted by the media content consumer, the transfer protocol GET request comprising an indication of a requested portion of the media file. The indication of the requested portion of the media file may comprise offset information defining one or more requested fragments of the media file. The at least one memory and stored computer program code may be configured to, working with the at least one processor, cause the apparatus of this embodiment to provide the at least a portion of the media file using a transfer protocol by providing the requested portion of the media file to the media content consumer in response to the transfer protocol GET request.

In another example embodiment, a computer program product is provided. The computer program product of this embodiment includes at least one computer-readable storage medium having computer-readable program instructions stored therein. The computer program product of this embodiment comprises program instructions configured, when executed by a processor, to cause an apparatus to establish a first communication channel with a media content consumer. The computer program product of this embodiment further comprises program instructions configured, when executed by a processor, to cause an apparatus to provide, by the first communication channel, at least a portion of a metadata file describing media data content of a media file. The computer program product of this embodiment additionally comprises program instructions configured, when executed by a processor, to cause an apparatus to establish a second communication channel with the media content consumer. The computer program product of this embodiment also comprises program instructions configured, when executed by a processor, to cause an apparatus to provide, by the second communication channel, at least a portion of the media file, the provided at least a portion of the media file requested by the media content consumer based at least in part on information in the provided at least a portion of the metadata file.

The program instructions configured to cause an apparatus to provide the at least a portion of the metadata file may comprise instructions configured, when executed by a processor, to cause an apparatus to provide the at least a portion of the metadata file as a series of fragments or to provide the at least a portion of the metadata file by streaming the metadata file to the media content consumer.

The at least a portion of the metadata file of this embodiment may comprise indexing information for media data fragments comprising the media file. The fragments comprising the media file may each have a predefined duration. The computer program product of this embodiment may further comprise program instructions configured, when executed by a processor, to cause an apparatus to receive a request transmitted by the media content consumer comprising offset information defining at least one media data fragment, wherein the offset information is determined by the media content consumer based at least in part on the indexing information. The program instructions configured to cause an apparatus to provide the at least a portion of the media file may comprise instructions configured, when executed by a processor, to cause an apparatus to provide the at least one media data fragment defined by the offset information included in the request.

The metadata file of this embodiment may comprise an ISOFF (International Organization for Standardization (ISO) base media file format) compliant file. The ISOFF-compliant metadata file may comprise only metadata boxes without any media data. The metadata file may comprise indexing information indexing fragments of media data in the media file. The metadata file may be arranged as a plurality of fragments.

The first and second communication channels of this embodiment may comprise transport layer protocol communication channels. The transport layer protocol communication channels may comprise transmission control protocol communication channels. The program instructions configured to cause an apparatus to provide the at least a portion of the metadata may comprise instructions configured, when executed by a processor, to cause an apparatus to provide the at least a portion of the metadata file using a transfer protocol. The transfer protocol may comprise hypertext transfer protocol. The program instructions configured to cause an apparatus to provide the at least a portion of the media file may comprise instructions configured, when executed by a processor, to cause an apparatus to provide the at least a portion of the media file using a transfer protocol. The transfer protocol may comprise hypertext transfer protocol.

The computer program product of this embodiment may further comprise instructions configured, when executed by a processor, to cause an apparatus to receive a transfer protocol GET request transmitted by the media content consumer, the transfer protocol GET request comprising an indication of a requested portion of the media file. The indication of the requested portion of the media file may comprise offset information defining one or more requested fragments of the media file. The program instructions configured to cause an apparatus to provide the at least a portion of the media file using a transfer protocol may comprise instructions configured, when executed by a processor, to cause an apparatus to provide the requested portion of the media file to the media content consumer in response to the transfer protocol GET request.

In another example embodiment, an apparatus is provided, which comprises means for establishing a first communication channel with a media content consumer. The apparatus of this embodiment further comprises means for providing, by the first communication channel, at least a portion of a metadata file describing media data content of a media file. The apparatus of this embodiment additionally comprises means for establishing a second communication channel with the media content consumer. The apparatus of this embodiment also comprises means for providing, by the second communication channel, at least a portion of the media file, the provided at least a portion of the media file requested by the media content consumer based at least in part upon the provided at least a portion of the metadata file.

In another example embodiment, a system is provided. The system of this embodiment comprises a media content consumer and a server. The media content consumer of this embodiment is configured to establish a first communication channel with the server. The media content consumer of this embodiment is further configured to retrieve from the server, by the first communication channel, at least a portion of a metadata file describing media data content of a media file. The media content consumer of this embodiment is additionally configured to establish a second communication channel with the server. The media content consumer of this embodiment is also configured to retrieve from the server, by the second communication channel, at least a portion of the media file based at least in part upon the retrieved at least a portion of the metadata file. The server of this embodiment is configured to provide, by the first communication channel, the at least a portion of the metadata file to the media content consumer. The server of this embodiment is further configured to provide, by the second communication channel, the at least a portion of the media file to the media content consumer.

As such, then, some embodiments of the invention provide several advantages to computing devices, computing device users, and network operators. Embodiments of the invention are configured to retrieve at least a portion of a metadata file describing a media file using a first communication channel with a server. Embodiments of the invention use the retrieved portion of the metadata file to identify a desired portion of the media file for retrieval and then retrieve the desired portion of the media file over a second communication channel with the server. In this regard, embodiments of the invention facilitate static streaming over a transfer protocol, such as hypertext transfer protocol (HTTP), in a way that may provide advantages to both a media content consumer and a server.

As a metadata describing a media file may be quite sizeable, embodiments of the invention provide an advantage in that embodiments of the invention split the metadata and media data into two separate files that are retrieved by a media content consumer over two separate communication channels. Accordingly, a media content consumer is enabled by embodiments of the invention to retrieve media data and begin playback of the media data before all of the metadata describing the media file has been retrieved. From the perspective of a user of a media content consumer, embodiments of the invention may provide a better user experience wherein requested media content is played back for the user with less of a delay following the initial request than delays incurred using previous streaming methods. Servers may benefit in that embodiments of the invention allow a server to write a metadata file describing streaming live content piece by piece as more media data content becomes available. Accordingly, embodiments of the invention are suitable for streaming of live content, where the metadata file is written piece by piece as more content becomes available. The media content consumer may then retrieve the metadata file piece by piece using byte ranges and parse the metadata file to locate and retrieve the corresponding media samples.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A method comprising:
receiving a transport protocol request for at least a portion of a media file indicating that at least the portion of the media file is to be streamed to a content consumption device requesting the media file;
determining, via a processor, a plurality of fragments to be transmitted to the content consumption device based upon the transfer protocol request; and
providing for transmission of the plurality of fragments to the content consumption device in response to the transfer protocol request.

2. A method according to claim 1 wherein receiving the transport protocol request comprises receiving the transport protocol request that identifies the portion of the media file to be streamed by at least one of identifying a time interval, identifying at least one scene or identifying a plurality of frames.

3. A method according to claim 1 wherein receiving the transport protocol request comprises receiving the transfer protocol request that identifies different types of tracks, and wherein providing for transmission of the plurality of fragments comprises providing for transmission a plurality of fragments of each of the different types of tracks.

4. A method according to claim 3 wherein providing for transmission of the plurality of fragments comprises providing for transmission of a plurality of fragments that contain multiplexed media data from each of the different types of tracks.

5. A method according to claim 1 further comprising formatting at least the portion of the media file into a plurality of fragments in response to the transfer protocol request.

6. A computer program product comprising at least one computer-readable storage medium having computer-executable program code instructions stored therein that, upon execution by the processor, cause performance of the method of claim 1.

7. An apparatus comprising at least one processor and at least one memory storing computer program code, the at least one memory and the computer program code configured to, with the at least one processor, cause the apparatus to:
receive a transport protocol request for at least a portion of a media file indicating that at least the portion of the media file is to be streamed to a content consumption device requesting the media file;
determine a plurality of fragments to be transmitted to the content consumption device based upon the transfer protocol request; and
provide for transmission of the plurality of fragments to the content consumption device in response to the transfer protocol request.

8. An apparatus according to claim 7 wherein the at least one memory and the computer program code are configured to, with the at least one processor, cause the apparatus to receive the transport protocol request by receiving the transport protocol request that identifies the portion of the media file to be streamed by at least one of identifying a time interval, identifying at least one scene or identifying a plurality of frames.

9. An apparatus according to claim 7 wherein the at least one memory and the computer program code are configured to, with the at least one processor, cause the apparatus to receive the transport protocol request by receiving the transfer protocol request that identifies different types of tracks, and to provide for transmission of the plurality of fragments by providing for transmission a plurality of fragments of each of the different types of tracks.

10. An apparatus according to claim 9 wherein the at least one memory and the computer program code are configured to, with the at least one processor, cause the apparatus to provide for transmission of the plurality of fragments by providing for transmission of a plurality of fragments that contain multiplexed media data from each of the different types of tracks.

11. An apparatus according to claim 7 wherein the at least one memory and the computer program code are configured to, with the at least one processor, further cause the apparatus to format at least the portion of the media file into a plurality of fragments in response to the transfer protocol request.

12. A method comprising:
directing, via a processor, issuance of a transfer protocol request for at least a portion of a media file indicating that at least a portion of the media file is to be streamed from a server; and
receiving a plurality of fragments from the server in response to the transfer protocol request.

13. A method according to claim 12 wherein directing issuance of the transfer protocol request comprises directing issuance the transport protocol request that identifies the portion of the media file to be streamed by at least one of identifying a time interval, identifying at least one scene or identifying a plurality of frames.

14. A method according to claim 12 wherein directing issuance of the transfer protocol request comprises directing issuance of the transfer protocol request that includes an identification of different types of tracks to be streamed, and wherein receiving the plurality of fragments comprises receiving the plurality of fragments of each of the different types of tracks.

15. A method according to claim 12 wherein directing issuance of the transfer protocol request comprises directing issuance of the transfer protocol request including an identification of a protocol via which the media file is to be streamed.

16. A computer program product comprising at least one computer-readable storage medium having computer-executable program code instructions stored therein that, upon execution by the processor, cause performance of the method of claim 12.

17. An apparatus comprising at least one processor and at least one memory storing computer program code, the at least one memory and the computer program code configured to, with the at least one processor, cause the apparatus to:
direct issuance of a transfer protocol request for at least a portion of a media file indicating that at least a portion of the media file is to be streamed from a server; and
receive a plurality of fragments from the server in response to the transfer protocol request.

18. An apparatus according to claim 17 wherein the at least one memory and the computer program code are configured to, with the at least one processor, cause the apparatus to direct issuance of the transfer protocol request by directing issuance the transport protocol request that identifies the portion of the media file to be streamed by at least one of identifying a time interval, identifying at least one scene or identifying a plurality of frames.

19. An apparatus according to claim 17 wherein the at least one memory and the computer program code are configured to, with the at least one processor, cause the apparatus to direct issuance of the transfer protocol request by directing issuance of the transfer protocol request that includes an identification of different types of tracks to be streamed, and to receive the plurality of fragments by receiving the plurality of fragments of each of the different types of tracks.

20. An apparatus according to claim 17 wherein the at least one memory and the computer program code are configured to, with the at least one processor, cause the apparatus to direct issuance of the transfer protocol request by directing issuance of the transfer protocol request including an identification of a protocol via which the media file is to be streamed.
